(19) United States
(12) Patent Application Publication
(10) Pub. No.: US 2025/0066209 A1
(43) Pub. Date: Feb. 27, 2025

(54) PROCESS FOR PREPARATION OF HIGH SILICA Y-ZEOLITE USING WASTE SILICA SOURCE

(71) Applicant: HINDUSTAN PETROLEUM CORPORATION LIMITED, Tarabanahalli (IN)

(72) Inventors: Hemant MISHRA, Bengaluru (IN); Sanju KUMARI, Bengaluru (IN); Pramod KUMAR, Bengaluru (IN); Sriram S, Bengaluru (IN)

(21) Appl. No.: 18/513,808

(22) Filed: Nov. 20, 2023

(30) Foreign Application Priority Data
Aug. 24, 2023 (IN) 202341056884

(51) Int. Cl. C01B 39/24; B01J 29/08; B01J 35/10; C10G 11/05

(52) U.S. Cl. CPC C01B 39/24; B01J 29/084; B01J 35/617; C10G 11/05; C01P 2006/12

(57) ABSTRACT

The present invention discloses a process for preparation of high silica Y-zeolite by utilizing waste silica source. The steps include preparing a dilute nucleating agent, preparing a dense nucleating agent by mixing sodium silicate, sodium aluminate, deionized water and sodium hydroxide. Further, preparing an aluminosilicate gel by mixing the dilute nucleating agent with sodium silicate, aluminium sulphate, deionized water and dense nucleating agent, followed by crystallizing the aluminosilicate gel filtering and washing to obtain a Y-zeolite cake. The Y-zeolite is ammonia exchanged, dried and calcined to obtain high silica Y-zeolite.

### CROSS-REFERENCE TO RELATED APPLICATION

This application is a U.S. Nonprovisional application and claims priority to Indian Application No. 202341056884, filed on Aug. 24, 2023, which is incorporated herein by reference in its entirety.

### FIELD OF INVENTION

The present disclosure generally relates to highly siliceous Y-zeolite and process for preparing the same. Specifically, the present disclosure relates to a process for utilizing waste silica source for preparation of high silica Y-zeolite.

### BACKGROUND OF INVENTION

Synthetic Y-zeolite has been in use as a key active component of a Fluid Catalyst Cracking catalyst for over past 50 years. In the process of synthesis of Y-zeolite/13X zeolite, sources of silica, alumina and sodium hydroxide are used. In synthesis step, alumina is almost completely consumed, whereas major part of silica remains unused. This unconsumed silica goes in mother liquor. This silica rich mother liquor can be used as silica source for synthesis of highly siliceous Y-zeolite. This will help in solving environmental pollution problem and as well as reduce the synthesis cost of Y-zeolite.

U.S. Pat. No. 3,898,319A discloses a process for preparing zeolite Y wherein the process which utilizes solid reactive silica derived from waste liquors from previous zeolite synthesis reactions. The synthesis is done by supplementing waste liquor with sodium silicate and chemically precipitating silica with carbon dioxide under particular conditions.

U.S. Pat. No. 4,164,551A discloses a process for preparing Type Y-zeolite, wherein zeolite crystallization mother liquor which contains excess silicate is combined with an acid aluminium salt to obtain a precipitated silica-alumina hydrogel.

US20040053773A1 discloses a process for the elimination of undesired excess silica and sodium salts from the mother liquor obtained after the isolation of molecular sieves and paves a way for complete recycling of said mother liquor. Sodium hydroxide is neutralized with a dilute mineral acid, till the final pH value of the acid-mother liquor is in the range of 9 to 12.5 at low temperature in the range of 5 to 25° C. This results in enrichment of silica and reduction in the quantity of undesired sodium salts and sodium salts in the mother liquor.

The amount of silica and sodium salts present in the waste mother liquor is high, which needs to be neutralized before disposal. If it is discarded without treatment, it can lead to environmental pollution. Therefore, it is essential to recycle and reuse the unconverted silica and sodium salts in waste zeolite mother liquor. Accordingly, the present invention provides a solution to this problem by utilizing waste zeolite mother liquor as a silica source for synthesis of highly siliceous Y-zeolite.

### SUMMARY OF THE INVENTION

The present disclosure relates to highly siliceous Y-zeolite. The present invention particularly relates to a process for preparation of high silica Y-zeolite by utilizing waste zeolite mother liquor, wherein zeolite mother liquor may be mother liquor from Y zeolite synthesis or mother liquor from 13X zeolite synthesis or mother liquor from zeolite 4A synthesis. The process includes steps of preparing a dilute nucleating agent by ageing zeolite mother liquor at a temperature in a range of 40-50° C. for 24-36 hours. Then preparing a dense nucleating agent by mixing sodium silicate, sodium aluminate and sodium hydroxide and deionized water and ageing at a temperature in a range of 35-45° C. for 20-24 hours.

Then preparing an aluminosilicate gel by mixing the dilute nucleating agent with sodium silicate, aluminium sulphate, deionized water, dense nucleating agent and crystallizing the aluminosilicate gel at a temperature in a range of 100-110° C. for 20-24 hours, filtering and washing to obtain a Y-zeolite cake. Thereafter, drying the Y-zeolite cake at 100-110° C. for 5 hours, followed by ammonium ion exchange, followed by calcination at 500-550° C. for 3 hours to obtain high silica Y-zeolite.

### DESCRIPTION OF THE ACCOMPANYING DRAWINGS

These and other features, aspects, and advantages of the present disclosure will become better understood when the following detailed description is read with reference to the accompanying drawings in which like characters represent like parts throughout the drawings, wherein:

FIG. 1 illustrates process flow scheme for preparation of high silica Y-zeolite using waste silica source.

### DETAILED DESCRIPTION OF THE INVENTION

The present disclosure addresses the drawbacks of the art and provides a process for preparation of High silica Y-zeolite using waste silica source. In some embodiments, the process provides recycling and reusing the waste silica source to reduce the environmental pollution by utilizing waste silica as a silica source for synthesis of high silica Y-zeolite.

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates. Unless otherwise defined, all technical and scientific terms used herein have the same meaning as commonly understood by one of ordinary skilled in the art to which this disclosure belongs. The system, methods, and examples provided herein are illustrative only and not intended to be limiting.

Although any methods and materials similar or equivalent to those described herein can also be used in the practice or testing of the present disclosure, the preferred methods and materials are now described. All publications mentioned herein are incorporated herein by reference to disclose and describe the methods and/or materials in connection with which the publications are cited.

It must be noted that as used herein and in the appended claims, the singular forms “a”, “and”, and “the” include plural referents unless the context dictates otherwise. Thus, for example, reference to “a compound” includes a plurality of such compounds, and reference to “the step” includes reference to one or more steps and equivalents thereof known to those skilled in the art, and so forth.

The term “some” as used herein is defined as “none, or one, or more than one, or all.” Accordingly, the terms “none,” “one,” “more than one,” “more than one, but not all” or “all” would all fall under the definition of “some.” The term “some embodiments” may refer to no embodiments or to one embodiment or to several embodiments or to all embodiments. Accordingly, the term “some embodiments” is defined as meaning “no embodiment, or one embodiment, or more than one embodiment, or all embodiments.”

The terminology and structure employed herein is for describing, teaching and illuminating some embodiments and their specific features and elements and does not limit, restrict or reduce the spirit and scope of the claims or their equivalents.

More specifically, any terms used herein such as but not limited to “includes”, “comprises”, “has”, “consists” and grammatical variants thereof is inclusive or open-ended and does not exclude additional, unrecited elements or method steps. The specification will be understood to also include embodiments which have the transitional phrase “consisting of” or “consisting essentially of” in place of the transitional phrase “comprising.” The transitional phrase “consisting of” excludes any element, step, or ingredient not specified in the claim, except for impurities associated therewith. The transitional phrase “consisting essentially of” limits the scope of a claim to the specified materials or steps “and those that do not materially affect the basic and novel characteristic(s)” of the claimed disclosure.

Whether or not a certain feature or element was limited to being used only once, either way it may still be referred to as “one or more features” or “one or more elements” or “at least one feature” or “at least one element.” Furthermore, the use of the terms “one or more” or “at least one” feature or element do NOT preclude there being none of that feature or element, unless otherwise specified by limiting language such as “there NEEDS to be one or more.” or “one or more element is REQUIRED.”

As used herein, the term “about” is used to indicate a degree of variation or tolerance in a numerical or quantitative value. It indicates that the disclosed value is not intended to be strictly limiting, and may vary by plus or minus 5%, without departing from the scope of the invention.

Unless otherwise defined, all terms, and especially any technical and/or scientific terms, used herein may be taken to have the same meaning as commonly understood by one having an ordinary skill in the art.

Reference is made herein to some “embodiments.” It should be understood that an embodiment is an example of a possible implementation of any features and/or elements presented in the attached claims. Some embodiments have been described for the purpose of illuminating one or more of the potential ways in which the specific features and/or elements of the attached claims fulfil the requirements of uniqueness, utility and non-obviousness.

Use of the phrases and/or terms such as but not limited to “a first embodiment,” “a further embodiment,” “an alternate embodiment,” “one embodiment,” “an embodiment,” “multiple embodiments,” “some embodiments,” “other embodiments,” “further embodiment”, “furthermore embodiment”, “additional embodiment” or variants thereof do NOT necessarily refer to the same embodiments. Unless otherwise specified, one or more particular features and/or elements described in connection with one or more embodiments may be found in one embodiment, or may be found in more than one embodiment, or may be found in all embodiments, or may be found in no embodiments. Although one or more features and/or elements may be described herein in the context of only a single embodiment, or alternatively in the context of more than one embodiment, or further alternatively in the context of all embodiments, the features and/or elements may instead be provided separately or in any appropriate combination or not at all. Conversely, any features and/or elements described in the context of separate embodiments may alternatively be realized as existing together in the context of a single embodiment.

As used herein, the term “waste” refers to unwanted or unusable materials.

As used herein the terms “method” and “process” have been used interchangeably.

The present disclosure discloses a process for preparation of high silica Y-zeolite by utilizing waste silica source.

In some embodiments, the process comprises preparing a dilute nucleating agent, preparing a dense nucleating agent; preparing an aluminosilicate gel by mixing the dilute nucleating agent with sodium silicate, aluminium sulphate, deionized water and dense nucleating agent; and crystallizing the aluminosilicate gel to obtain high silica Y-zeolite.

The process of the present disclosure provides high silica Y-zeolite which can be prepared by utilizing waste silica source.

The present disclosure discloses a process for preparation of high silica Y-zeolite by utilizing waste silica source, wherein the process includes steps of a) preparing a dilute nucleating agent by ageing a waste silica source at a temperature in a range of 40-50° C. for 24-36 hours; b) preparing a dense nucleating agent by mixing sodium silicate, sodium aluminate, sodium hydroxide and deionized water, followed by ageing at a temperature in a range of 35-45° C. for 20-24 hours; c) preparing an aluminosilicate gel by mixing the dilute nucleating agent with sodium silicate, aluminium sulphate, deionized water and dense nucleating agent; d) crystallizing the aluminosilicate gel obtained from step c) at a temperature in a range of 100-110° C. for 20-24 hours, filtering and washing to obtain a Y-zeolite cake, drying the Y-zeolite cake at 100° C.-110° C. for 5 hours, ammonium-exchange for sodium removal followed by calcination at 500° C.-550° C. for 3 hours to obtain high silica Y-zeolite.

In an embodiment of present invention, there is provided the process, wherein the waste silica source is aged for 24-36 hours at 40-50° C.

In another embodiment, wherein the waste silica source is aged for 24-36 hours at 40-50° C.

In a preferred embodiment, wherein the waste silica source is aged for 25-35 hours at 42-48° C.

In another embodiment of present invention, there is provided the process, wherein the waste silica source is selected from Y-zeolite mother liquor, 13X zeolite mother liquor, and Zeolite 4A mother liquor.

In a preferred embodiment of present invention, there is provided the process, wherein the waste silica source is selected from Y zeolite mother liquor and 13X zeolite mother liquor.

In another embodiment of present invention, there is provided the process, wherein waste silica source consists of SiO₂/SO₄ of 1-10.

In a preferred embodiment of present invention, there is provided the process, wherein the SiO₂/SO₄ of waste silica source is 3-6.

In yet another embodiment of present invention, there is provided the process, wherein waste silica source consists of SiO₂/Na₂O of 1-5.

In a preferred embodiment of present invention, there is provided the process, wherein waste silica source consists of SiO₂/Na₂O of 1-3.

In yet another embodiment of present invention, there is provided a process, wherein the dense nucleating agent is prepared by mixing sodium aluminate and sodium hydroxide in deionized water to obtain a first solution, mixing sodium silicate in deionized water to obtain a second solution, mixing the first solution and the second solution and the obtained solution is aged at 35-45° C. for 20-24 hours.

In one more embodiment of present invention, there is provided the process, wherein, the aluminosilicate gel is prepared by mixing dilute nucleating agent, sodium, adding aluminium sulphate solution, deionized water and dense nucleating agent.

In another embodiment of present invention, there is provided the process, wherein aluminosilicate gel composition is SiO₂:Na₂O:Al₂O₃:SO₄:H₂O in ratio of 7-20:2-10:1:0-5:200-400.

In a preferred embodiment of present invention, there is provided the process, wherein aluminosilicate gel composition is SiO₂:Na₂O:Al₂O₃:SO₄:H₂O in ratio of 10-15:5-10:1:0-2:200-300.

In one more embodiment of present invention, crystallization of aluminosilicate gel is carried out at a temperature in a range of 100-110° C. for 20-24 hours, filtering and washing to obtain a Y-zeolite cake, drying the Y-zeolite cake at 100-110° C. for 5 hours, ammonium-exchange for sodium removal followed by calcination at 500-550° C. for 3 hours to obtain high silica Y-zeolite.

In one more embodiment of present invention, there is provided the process, wherein ammonia ion exchange is performed with an ammonium salt selected from ammonium nitrate, ammonium sulphate, ammonium chloride or combination thereof.

In an embodiment of present invention, there is provided the process, wherein the Y-zeolite have surface area of 900-950 m²/g.

In one more embodiment of present invention, there is provided the process, wherein the high silica Y-zeolite has unit cell size of 24.55-24.65 Angstrom.

In one more embodiment of present invention, there is provided the process, wherein the high silica Y-zeolite has a framework SiO₂/Al₂O₃ of 5-7.

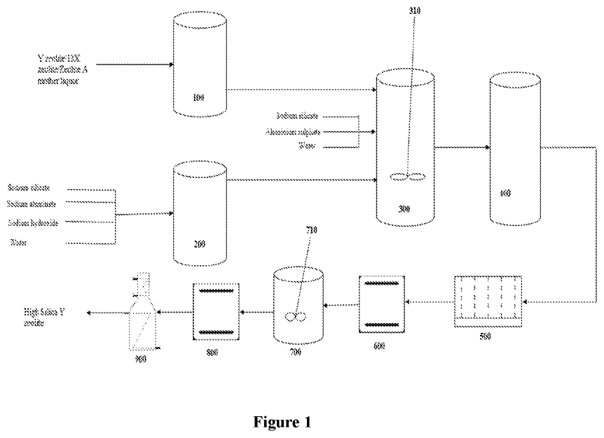

In an exemplary and non-limiting embodiment, referring to FIG. 1, the process for preparation of high silica Y-zeolite by utilizing waste silica source is illustrated. The dilute nucleating agent is prepared by ageing a waste silica source at a temperature in a range of 40-50° C. for 24-36 hours in a vessel (100). The dense nucleating agent is prepared by mixing sodium silicate, sodium aluminate, sodium hydroxide and deionized water in a vessel (200) and ageing is done at a temperature in a range of 35-45° C. for 20-24 hours. The aluminosilicate gel is prepared by mixing the dilute nucleating agent with sodium silicate, aluminium sulphate, deionized water and dense nucleating agent in a vessel (300) using a stirrer (310). The aluminosilicate gel is crystallized in an autoclave (400) at a temperature in a range of 100-110° C. for 20-24 hours, filtering and washing in a centrifuge filtration unit (500) to obtain a Y-zeolite cake, drying the Y-zeolite cake in an air oven (600) at 100-110° C. for 5 hours, ammonium-exchange for sodium removal in vessel (700), drying it at 100-110° C. in an air oven (800) followed by calcination in muffle furnace (900) at 500-550° C. for 3 hours to obtain high silica Y-zeolite.

### EXAMPLES

The present disclosure is further illustrated by reference to the following examples which is for illustrative purpose only and does not limit the scope of the disclosure in any way. These examples are not intended to be inclusive of all aspects of the subject matter disclosed herein, but rather to illustrate representative features, methods, compositions, and results. These examples are not intended to exclude equivalents and variations of the present disclosure, which are apparent to one skilled in the art.

### Example 1: Preparation of Dense Nucleating Agent

12 g sodium aluminate is dissolved in 70 g deionized water under stirring. 25.6 g of sodium hydroxide is dissolved in sodium aluminate solution, named as solution 1. 112 g sodium silicate is dispersed in 75 g deionized water under stirring, named as solution 2. Solution 1 is added in solution 2 under vigorous stirring. After stirring, dense nucleating agent is aged at 35° C. for 24 hours.

### Example 2: Preparation of Dilute Nucleating Agent

Dilute nucleating agent is prepared from waste silica source, wherein waste silica source used are Y-zeolite mother liquor/13X zeolite mother. 875 g of Y-zeolite mother liquor is aged for 30 hours at 45° C. for obtaining dilute nucleating agent.

### Example 3: Preparation of High Silica Y-Zeolite

875 g of dilute nucleating agent is added to 357 g sodium silicate and diluting with 100 g deionized water. To this solution 269 g of dense nucleating agent is added and solution is stirred vigorously. 257 g aluminium sulphate is dissolved in 500 g of deionized water under stirring until clear solution is prepared. Aluminium sulphate solution is dropwise added in above prepared solution under stirring. Solution is kept under vigorous stirring for 30 minutes. Prepared aluminosilicate is crystallized at 105° C. for 24 hours. After completion of crystallization, zeolite is filtered and washed. The obtained Y-zeolite cake is dried at 100-110° C. for 5 hours. After drying, obtained Y zeolite is four times ammonium ion exchanged using 5 wt % ammonium sulphate solution. Sample is filtered, washed and dried at 100-110° C. for 5 hours and obtained Y zeolite is calcined at 500° C. for 3 h and obtained Y zeolite is named as HSY-zeolite. Steaming of HSY-zeolite sample is done at 810° C. for 5 hours. The steamed powder is named as HSY-Zeolite-St.

### Comparative Example 1: Preparation of HY-Zeolite-St

87.5 g of aluminium sulphate is dissolved in 500 g of deionized water under stirring and clear aluminium sulphate solution is prepared. 73.5 g of sodium aluminate is dissolved in 300 g of deionized water.

741 g sodium silicate is dissolved in 100 g deionized water under stirring and silica solution is prepared. Firstly, sodium aluminate solution is dropwise added in silica solution and then aluminium sulphate solution is added in solution and aluminosilicate gel is prepared.

269 gm of dense nucleating agent prepared in example 1 is added in aluminosilicate gel. Solution is kept under vigorous stirring for 30 minutes. Prepared aluminosilicate is crystallized at 105° C. for 24 hours. After completion of crystallization, zeolite is filtered and washed. The obtained Y-zeolite cake is dried at 100° C.-110° C. for 5 hours. After drying, obtained Y zeolite is four times ammonium ion exchanged using 5 wt % ammonium sulphate solution. Sample is filtered, washed and dried at 100-110° C. for 5 hours and obtained Y zeolite is calcined at 500° C. for 3 h and obtained Y zeolite is named as HY-zeolite. Steaming of HY-zeolite sample is done at 810° C. for 5 hours. The steamed powder is named as HY-Zeolite-St.

### Comparative Example 2: Preparation of HCY-Zeolite-St

Commercial NaY-zeolite is four times ion exchanged using 5 wt % ammonium sulphate solution. Sample is filtered, washed and dried at 100-110° C. for 5 hours and obtained dried zeolite is calcined at 500° C. and obtained Y zeolite is named as HCY-zeolite. Steaming of HCY-zeolite sample is done at 810° C. for 5 hours. The steamed powder sample is named as HCY-Zeolite-St.

TABLE 1
Textural properties of Y-zeolite samples

| | Comparative | Comparative | |
|---|---|---|---|
| Properties | example 1 | example 2 | Example 3 |
| Unit cell | 24.67 | 24.65 | 24.60 |
| size, Angstrom | | | |
| Framework | 4.96 | 5.0 | 6.2 |
| SiO_{2/}Al₂O₃ molar | | | |
| ratio | | | |
| Total | 830.5 | 931.6 | 928 |
| surface area, m²/g | | | |
| Micropore | 788.4 | 884.2 | 875.7 |
| surface area, m²/g | | | |
| External | 42.1 | 47.4 | 52.9 |
| surface area, m²/g | | | |

### Example 4

Cracking performance of steamed Y-zeolites was tested in a fixed bed reactor. The amount of catalyst used was 5 g, decane feed rate was about 2 g/min, injection time was 30 seconds, reaction temperature was maintained at about 500° C., the reaction pressure was 1 kg/cm²g and regeneration temperature was maintained at about 700° C. Catalytic cracking performance evaluation of steamed Y-zeolites: HY-Zeolite-St, HCY-Zeolite-St and HSY-Zeolite-St was carried out using n-decane as feed. Table 2 lists the conversion and product yields obtained with different Y-zeolites in various examples.

TABLE 2
Catalytic Cracking performance evaluation
of Y-zeolites in fixed bed reactor

| Catalyst | Comparative | Comparative | |
|---|---|---|---|
| Name | example 1 | example 2 | Example 3 |
| Feed Name | n-decane | n-decane | n-decane |
| Reactor | 500 | 500 | 500 |
| Temperature, ° C. | | | |
| Cat/Oil | 5 | 5 | 5 |
| (wt/wt) | | | |

Yields (wt. %)

| | | | |
|---|---|---|---|
| Dry Gas | 1.69 | 1.85 | 3.68 |
| LPG | 28.91 | 34.16 | 40.56 |
| Coke | 8.03 | 8.95 | 10.97 |
| Gasoline | 59.56 | 53.90 | 43.88 |
| Light Cycle | 1.36 | 1.14 | 0.91 |
| Oil | | | |
| Resid | 0.45 | 0 | 0 |
| Propylene | 3.11 | 4.0 | 4.2 |
| Ethylene | 0.59 | 0.72 | 1.22 |
| Butylene | 2.46 | 2.63 | 2.98 |
| Total Light | 6.16 | 7.35 | 8.4 |
| olefins | | | |

### Advantages of Present Invention

The advantage of the present invention over the prior art is that Y-zeolite prepared using waste silica source increases silica to alumina ratio of Y-zeolite and hence increases LPG selectivity and light olefin selectivity. It reduces the environmental pollution as well as reduces the cost of preparation of high silica Y-zeolite.

We claim:

1. A process for preparation of a high silica Y-zeolite by utilizing a waste silica source, wherein the process comprises steps of:
a. preparing a dilute nucleating agent by ageing the waste silica source at a temperature in a range of 40-50° C. for 24-36 hours;
b. preparing a dense nucleating agent by mixing sodium silicate, sodium aluminate, sodium hydroxide and deionized water, followed by ageing at a temperature in a range of 35-45° C. for 20-24 hours;
c. preparing an aluminosilicate gel by mixing the dilute nucleating agent with sodium silicate, aluminium sulphate, deionized water and dense nucleating agent; and
d. crystallizing the aluminosilicate gel obtained from step c) at a temperature in a range of 100-110° C. for 20-24 hours, filtering and washing to obtain a Y-zeolite cake, drying the Y-zeolite cake at 100-110° C. for 5 hours, ammonium-exchange for sodium removal followed by calcination at 500-550° C. for 3 hours to obtain high silica Y-zeolite.

2. The process as claimed in claim 1, wherein the waste silica source is aged at 42-48° C. for 25-35 hours.

3. The process as claimed in claim 1, wherein the waste silica source is selected from a Y-zeolite mother liquor, a 13X zeolite mother liquor and a zeolite 4A mother liquor.

4. The process as claimed in claim 3, wherein the waste silica source is selected from the Y-zeolite mother liquor and the 13X zeolite mother liquor.

5. The process as claimed in claim 1, wherein the waste silica source consists of molar ratio of SiO₂/SO₄ of 1-10.

6. The process as claimed in claim 5, wherein the waste silica source consists of molar ratio of SiO₂/SO₄ of 3-6.

7. The process as claimed in claim 1, wherein the waste silica source consists of molar ratio of SiO₂/Na₂O of 1-5.

8. The process as claimed in claim 7, wherein SiO₂/Na₂O of the waste silica source is 1-3.

9. The process as claimed in claim 1, wherein aluminosilicate gel molar composition is SiO₂:Na₂O:Al₂O₃:SO₄:H₂O in a ratio of 7-20:2-10:1:0-5:200-400.

10. The process as claimed in claim 9, wherein the aluminosilicate gel molar composition is SiO₂:Na₂O:Al₂O₃:SO₄:H₂O in a ratio of 10-15:5-10:1:0-2:200-300.

11. The process as claimed in claim 1, wherein the high silica Y-zeolite have a surface area of 900-950 m²/g.

12. The process as claimed in claim 1, wherein the high silica Y-zeolite have unit cell size of 24.55-24.65 Angstrom.

13. The process as claimed in claim 1, wherein the high silica Y-zeolite have a framework SiO₂/Al₂O₃ of 5-7.
